(19) United States
(12) Patent Application Publication
(10) Pub. No.: US 2017/0112596 A1
(43) Pub. Date: Apr. 27, 2017

(54) RETAINER

(71) Applicant: Neurodontics-Stiftung, Hannover (DE)

(72) Inventor: Wilhelm ENTRUP, Hannover (DE)

(73) Assignee: Neurodontics-Stiftung, Hannover (DE)

(21) Appl. No.: 15/334,904

(22) Filed: Oct. 26, 2016

(30) Foreign Application Priority Data
Oct. 27, 2015 (DE) 10 2015 118 323.4

(51) Int. Cl. A61C 7/28; A61C 7/16; A61C 7/14

(52) U.S. Cl. CPC A61C 7/28; A61C 7/145; A61C 7/16

(57) ABSTRACT

A retainer for straightening and/or for maintaining the front teeth positioning achieved during orthodontic therapy, having at least two connection pieces for fastening the retainer on one tooth in each case and having a connection wire for establishing a connection among the teeth and/or for forming a constraint to restrict the movement capabilities of the connected teeth. In order to be able to prevent compensation reactions by the body, the connection wire is movably mounted in at least one of the connection pieces.

This application claims the benefit under 35 USC §119(a)-(d) of German Application No. 10 2015 118 323.4 filed Oct. 27, 2015, the entirety of which is incorporated herein by reference.

### FIELD OF THE INVENTION

The present invention relates to a retainer for straightening and/or for maintaining the teeth positioning achieved during orthodontic therapy.

### BACKGROUND OF THE INVENTION

Removable and fixed devices which lie passively on the teeth, connect the teeth together and, owing to their predefined shape, limit the movement capabilities of the teeth are known from the prior art. These devices are used for the purpose of fixing the teeth positioning achieved following an active orthodontic therapy, and for therefore preventing the teeth positioning from returning to the original situation or some other malocclusion from occurring.

DE 20 2012 004 419 U1 discloses a retainer for stabilizing a straightening of teeth and for making it permanent, this involving sticking the retainer wire used for this purpose on the teeth. WO 2007/014616A1 in turn discloses a retainer in which a clamping element is likewise adhesively bonded to the teeth, which clamping element is nevertheless used for the orthodontic treatment of teeth. Also for carrying out teeth treatment, an orthodontic device is known from DE 601 002 36 T2, which orthodontic device achieves straightening and thus treatment by exertion of a pushing force.

### SUMMARY OF THE INVENTION

It is an Object of the present invention to be able to provide a retainer in which the body is not forced to have to later compensate for the rigid constraints added thereto after an active teeth treatment by means of compensations such as, for example, postural compensations.

The retainer according to the present invention is designed for straightening, but especially for maintaining the teeth positioning achieved during orthodontic therapy, especially front teeth positioning. The retainer has at least two connection pieces for fastening the retainer on one tooth in each case, and also a connection wire for establishing the connection among the teeth and for forming a constraint to restrict the movement capabilities of the connected teeth. The respective connection pieces each form holding or anchoring points on the individual teeth in order to hold the connection wire, which establishes a connection from one tooth to the next. The connection establishes constraints, i.e., the movement capabilities of the teeth are absolutely restricted.

Now, the retainer according to the present invention is distinguished by the fact that the connection wire is movably mounted in at least one of the connection pieces. This movable mounting increases the movement capability of the retained teeth in comparison with a conventional, completely rigid fixation, as has been customary to date according to the prior art. In contrast to current expert opinion, it has emerged that it is not necessary to achieve, in conjunction with retainer, a completely rigid fixation, for instance by means of multiply stranded stainless steel wires, orthodontic polygonal wires or nickel-titanium wires. Such an absolutely rigid fixation which provides the tooth with no more movement capability can lead to this constraint measure having to be compensated for by neurological and muscular compensations of the body.

The osseous parts of the upper jaw (maxilla) are connected to one another via sutures (connective tissue-type seams between the bones). Even after the physiological ossification of the sutures, there is a physiological bending between the parts of the maxilla. This bending system of the cranial bones is the basis for the health of the craniomandibular system (abbreviation: CMS). The CMS is neurologically connected to the cervical spine and especially to the the dura mater with the craniosacral system and influences it significantly. Thus, the absence of the stated bending or movement capabilities can lead to postural compensations. The movement capabilities of these structures are, however, sigificantly influenced by the teeth, since they are in turn tightly connected to the bone via the periodontal fibers of the periodontium. An excessively rigid connection of the teeth due to dental/orthodontic measures, especially due to corresponding retainers, prevents this mobility.

Furthermore, the lower jaw is subject to a physiological flexion and torsion during the opening and closing movement, during chewing and also during breathing. This torsion ability of the stated structures is likewise influenced by the teeth, since they are in turn tightly connected to the bone via the periodontal fibers of the periodontium. Here too, an excessively rigid connection can again accordingly have an adverse effect on the stated torsion capabilities. Such constraint measures due to such a retainer can, at most, be compensated for in terms of chewing function by the body's own induced compensations. In the event of an exceedance of an individual threshold value with decompensation, which threshold value can vary from patient to patient (with iatrogenic symptoms such as cephalalgia, cervical/thoracic/lumbar spine complaints, cervicobrachialgia, paresthesia in the region of the extremities or other spinal syndromes), compensation reactions can occur in the body, which compensation reactions would describe the abovementioned adverse effects of an excessively rigid constraint.

Moreover, it should be noted that, although the required residence time of such a retainer in the mouth of the patient can vary very greatly depending on the case of treatment, a residence time of at least 5 years after completion of treatment can be generally assumed. An excessively rigid retainer, as is known from the prior art, thus represents a disruptive, iatrogenic intervention, the health-related consequences and adverse effects of which can thus be prevented, but at least attenuated.

In one embodiment of the present invention, the connection wire is designed to be substantially rigid in the longitudinal direction or can have, in particular, an elasticity modulus of at least 1000 MPa (megapascal), preferably at least 3000 MPa. Because of this, the connection wire is in this case barely extendable in the longitudinal direction. An (elastic) stretching of the wire in the longitudinal direction is therefore barely possible. If individual points of connection pieces are permanently connected to the wire, they cannot move further apart in the direction of longitudinal stretching of the wire. A relative movement between teeth and wire is, at most, possible depending on the design of the wire transverse to its longitudinal extent when the wire has appropriate properties or else the teeth can achieve a relative movement in relation to one another if allowed by the movable mounting of the connection wire in the corresponding connection pieces.

In particular, in one embodiment of the present invention, the connection wire can be designed to be nonrigid perpendicular to the longitudinal direction, i.e., bending in this direction is possible without great exertion of force. If necessary, the wire can also be stuck in the thereupon attained position or returned to the starting shape by means of an appropriate force. Depending on how the wire is designed and in which direction the movable mounting is possible, it is also possible to alter the constraints which are still present with regard to the movement capabilities of the teeth. In a particularly preferred development of the present invention, at least one of the connection pieces surrounds the connection wire perpendicular to the longitudinal direction of the connection wire, specifically at least in part, but especially in full. Furthermore, it is conceivable that the connection piece lies completely on the connection wire along its circumference. This measure allows preferably a relative movement between the connection wire and the particular connection piece in the longitudinal direction. A relative movement perpendicular to the longitudinal direction is permitted only within a specific area, this depending, for example, on whether the connection wire is guided in an eyelet of the connection piece, the cross section of which eyelet is similar in size to that of the connection wire, or how much play is allowed here. If the eyelet is designed such that the connection wire is mounted practically without any play, a movement perpendicular to the longitudinal axis of the connection wire is practically suppressed. By contrast, if a mounting with much play is provided, a movement is also possible within the corresponding cross-sectional area of the eyelet.

In exemplary embodiments of the present invention, the wire or the mounting eyelet of the connection piece can also have a specific cross-sectional shape. For example, the cross section can, in the simplest case, be a round cross section; however, an oval cross section of the wire is also conceivable. An oval cross section can prevent the wire from rotating around its own axis within the mounting eyelet. The oval shape can, depending on how much play is provided in the mounting eyelet of the connection piece, lead to a rotational movement around the longitudinal axis being merely restricted or being not possible at all. This mounting option allows altogether an increased movement capability of the teeth within the retainer structure. Two teeth can move relative to one another along the longitudinal axis of the wire, i.e., along the curvature of the upper or lower jaw, provided that they are not mutually blocking themselves (for instance, owing to the particular crown). A movement of the teeth is obtained/present within the natural mobility of teeth of 0.2 mm in all three directions in space. However, owing to the support of the connection wire, a completely free movement is also no longer possible.

According to the present invention, the connection wire is at least partly or entirely made of plastic, preferably of polyether ether ketone (abbreviation: PEEK). Completely omitting metallic components or materials allows an especially high degree of biocompatiblity. Furthermore, an esthetic improvement can be achieved, since metallic components generally also have a metallic shine and therefore distinctly set themselves apart optically from the natural dental material. Conventional retainers composed of metal are therefore often highly visible and stand out in the eyes of the observer as a disturbing object. Apart from that, PEEK as a plastics material is additionally distinguished by a high thermal stability.

The use of plastic, more particularly a PEEK wire, can avoid allergic reactions in patients having a corresponding allergological disposition, which can occur especially also in the case of stainless steel. The metallic and rigid appearance of a conventional retainer, as is known from the prior art, is often even rejected by some patients, meaning that they forgo an appropriate treatment and instead rather accept detriments to their health. For these patients, this invention therefore provides a new type of option.

Furthermore, according to the present invention, at least one of the connection pieces is at least partly, especially entirely, made of composite. Such composites are usually tooth-colored, plastic filling materials which usually consist of a plastics matrix, it being possible for the organic matrix to be admixed with inorganic fillers. In terms of esthetics, composites generally provide the advantage that they are suppliable in a plurality of colors, allowing an optimal matching to the existing teeth. Furthermore, they can usually be processed in a cost-effective manner and with little expenditure of time. The modeling can, where applicable, be performed in one sitting. Because the composite is a plastic material which is not yet solid during processing, it can be optimally matched to the corresponding spatial circumstances in the mouth or be indirectly prepared/processed in the laboratory.

Depending on the type of processing or on how the polymerization to be effected proceeds or is initiated, composites can be divided into chemically curing composites (usually designed as a two-component system) or as light-curing composites, which usually consist of a single-component system. In addition, there are also so-called dual-curing composites which are both light-curing and chemically curing. The composite matrix usually consists of plastics based on methacrylate. Fundamentally, possible fillers are glass, ceramic or quartz particles. In many cases, they are silane-coated. It is possible to vary the viscosity of the composite materials.

The fastening of the connection pieces to the tooth can, in particular, be done adhesively. Fastening is carried out by using an acid etching technique, which can be achieved with or without a laboratory step. In the exemplary embodiments of this kind, an etching of the corresponding tooth surface or denture surface is first carried out using an acid. This is followed by applying an adhesive which establishes the connection to the tooth surface in this area. Etching can be carried out by using, for example, phosphoric acid.

The combined use in a retainer as exemplary embodiment according to the present invention of PEEK for preparing the connection wire and of a composite as connection piece has the advantage that PEEK generally does not enter into a chemical or mechnical connection with the composite. This property can be advantageously utilized to allow a movable mounting of the PEEK wire in the composite. It is possible to allow a low-friction connection between wire and composite body (connection piece) or tooth.

Especially when the connection pieces lie on the inner side of the tooth, i.e., on the palatal or lingual surface, they are usually concealed from other people and thus esthetically virtually neutral.

In a particularly preferred development of the present invention, at at least one of the two ends of the connection wire, a stop is provided for the one-sided limitation of the relative movement between connection piece and connection wire in the longitudinal direction of the wire, especially a stop at least partly consisting of composite material. As a result of mechanical and chemical changes in the PEEK wire, it is possible to establish a permanent bond between composite and PEEK wire in order to establish an end limit. In this way, it is possible to fasten permanent stops on terminal teeth of the retainer compound structure, which stops ensure a defined arc length and prevent gap formation. This gives rise in the teeth space to a retainer arc which connects multiple teeth togther, the teeth being first movably mounted along the wire in its curved profile.

Two options are fundamentally conceivable for restricting mobility in the region of the terminal teeth.

Firstly, the wire can still be movably mounted in the terminal connection piece, while a stop is, however, provided at the end of the wire, which stop cannot be pulled through the connection piece and its mounting because it is, for example, designed to be excessively thick. In this case, a movement of the terminal tooth in a sideward manner away from the retainer structure is inhibited unless the entire structure were to substantially move in the same direction, which does not occur clinically.

Secondly, it would also be possible in principle to permanently connect the wire end directly to the connection piece. The wire can then no longer slide in the connection piece. As a result, a lateral movement in the direction of the rest of the retainer structure can also be inhibited (depending on the flexibility or elasiticty of the wire).

If, however, the terminal teeth move outwardly away from one another, they are blocked in both cases in a mutual manner owing to the attached end stops. Movement perpendicular to the profile direction of the wire is restricted too in that a tooth cannot drift laterally as desired without the entire structure blocking. This is, however, possible to a certain extent, and it is possible in principle for a tooth to move in the longitudinal direction of the wire too, at least to the extent allowed by the adjacent tooth on the basis of its extent, for example, on the basis of its crown's extent. In any case, a certain movement capability is, however, granted to the teeth affected by the retainer compound structure, and so other compensations of the constriction, which is represented by a retainer, are not automatically necessary, but instead a movement of these teeth to a physiological extent can be achieved in the first instance.

A retainer according to the present invention can, in particular, be used in the front teeth region, but is generally not restricted thereto.

Moreover, mobility can be adjusted by how large the eyelet in a connection piece is designed, in which connection piece a connection wire is mounted. According thereto, it is possible to set the size of the eyelet and thus the size of the play for a movement perpendicular to the profile of the wire. It is fundamentally possible to set a mobility of approximately 0.2 mm (millimeters), which approximately corresponds to the natural tooth mobility in the tooth socket; the natural mobility is thus maintained in all three directions in space owing to the slide properties within the structure along the longitudinal axis and also owing to the flexibility of the wire.

In particular, the following method steps can be carried out in a corresponding method of production for a retainer: Shaping at least one, especially two, connection pieces and passing or inserting a connection wire through at least two connection pieces.

Depending on how the composite material cures and how the polymerization takes place, it is possible to envisage a layer-by-layer construction of a connection piece, it being possible to insert the connection wire into at least one of the connection pieces during the construction, and so the particular connection piece then surrounds the connection wire at this point. This procedure can be used especially with light-curing composites.

The composite structure can be fundamentally realized with high precision and also with high strength of connection.

In the case of an entirely chemically curing material, the wire can optionally also be inserted in the plastic state.

Generally, it is therefore possible in one exemplary embodiment of the present invention for the connection pieces to be entirely made of composite. Firstly, it is therefore possible to use a composite having a color corresponding to the surrounding dental material, meaning that the connection piece itself is inconspicuous in the oral cavity. Secondly, the composite material has generally the desired friction properties with regard to the PEEK wire or some other plastics wire, meaning that the desired movable mounting is readily possible.

However, it is also conceivable to use a compound material for a connection piece, which compound material only partly uses composite material. In particular, it is optionally possible to make the end stop such that it adheres to another material introduced into the composite material. Fundamentally, it is also conceivable for the actual part forming the mount to comprise another material which has particular, desired frictional properties with the connection wire. Furthermore, it is conceivable to also additionally use materials for enhanced mounting on the tooth. Preferably, the connection wire is at least partly, especially entirely, made of plastic, especially of polyether ether ketone. However, it is also conceivable to use other materials in the end region in order to realize an end stop or a stop. Coatings of the wire too are fundamentally conceivable. Otherwise, in embodiments relating to the inventive method of production, it is possible to use the techniques already mentioned, for example, light curing or the use of a chemically curing composite, the formation of an end stop on the connection wire, especially by heating and also a chemical treatment of the PEEK wire in order to effect a reaction with the composite.

Furthermore, the application of an adhesive to the connection piece can also be envisaged for establishing a tooth connection.

### BRIEF DESCRIPTION OF THE DRAWINGS

An exemplary embodiment of the present invention is depicted in the drawings and will be more particularly elucidated below with further details and advantages being specified.

FIG. 1 shows a schematic representation of a retainer according to the present invention that has been attached to a group of teeth; and

FIG. 2 shows a schematic representation of a tooth with attached connection piece in the palatal region.

### DETAILED DESCRIPTION OF THE INVENTION

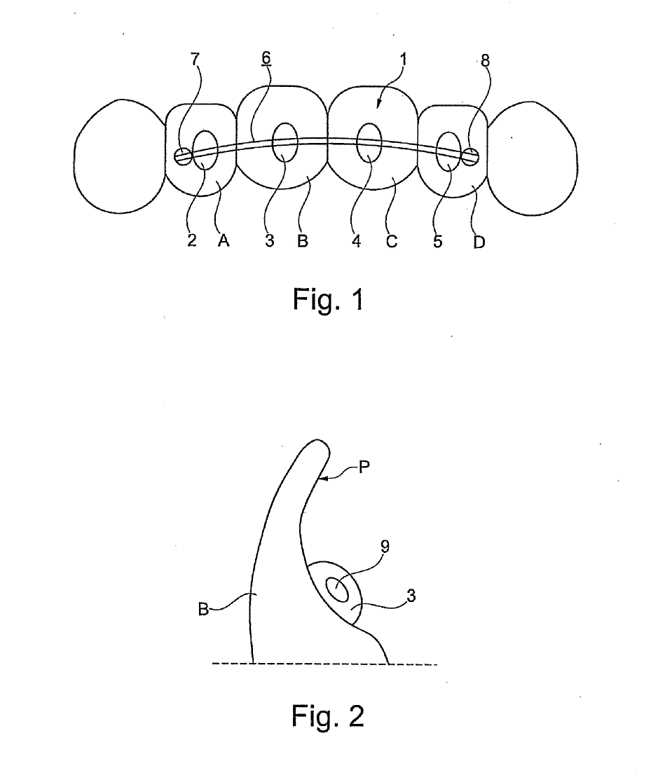

FIG. 1 shows a retainer 1 having connection pieces 2, 3, 4, 5. A connection wire 6 is passed through the connection pieces 2 to 5 and movably mounted. At the two ends of the connection wire 6, there are end stops 7, 8 in each case. The connection pieces themselves are attached in the palatal region to teeth a, b, c, d. The wire 6 is a PEEK wire. End stops in the form of beads or swellings 7, 8 are attached at the ends of the wire 6. There are fundamentally two options, specifically allowing the stops 7, 8 to interact with the particular composite material of the corresponding connection piece 2, 5 to form a permanent connection, or else maintaining a mobility of the wire 6, meaning that the tooth can only move up to the stop. Tooth A could, in FIG. 1, for example, move further to the left unless tooth D, in particular, can exert no movement whatsoever to the left.

When tooth B lies on stop 8 via the connection piece 5, the free movement of tooth A to the left is absolutely restricted. At most, a restricted movement is still possible owing to possible play of the wire 6 as a result of the curvature across the length of the entire retainer system. Teeth B and C can, to a certain extent, move laterally to the left or to the right via the movable mounting of the wire 6 in the connection pieces 3, 4, at least if the adjacent teeth still allow this. Nevertheless, the movement capabilities of teeth A to D are restricted to the extent that the orthodontic measure taken is maintained and the teeth misalignment remains successfully corrected.

FIG. 2 shows a side view of a tooth, for example, tooth B with a connection piece 3 attached to the palatal side P thereof. The connection piece in turn has an eyelet 9, the cross section of which is designed to be oval. Whether as wire, it is possible to use an oval wire 6 which is mounted in the eyelet 9. The wire can be mounted such that it is mounted in the eyelet 9 with play, for example, has still a movement capability of about 0.2 mm, the movement capability corresponding to the natural movement capabilities of the tooth in the tooth socket, making it still posible for the tooth to achieve its natural movement, despite the attached retainer. Nevertheless, the wire 6 cannot rotate in the eyelet 9, but is instead blocked by its oval shape.

Depending on whether the connection pieces are arranged in the region of the upper jaw or of the lower jaw, the sizes thereof can be from approximately 2 mm to 5 mm, more particularly from 2.5 mm to 5 mm. In the embodiments according to FIG. 1 and FIG. 2, the width in the horizontal direction is approximately 2.5 mm in the case of a lower-jaw use and approximately 3.5 mm in the case of an upper-jaw use. The length is about 3.5 mm in the region of the lower jaw and 4 mm in the region of the upper jaw. A possible wire diameter is a diameter of, in particular, 0.5 mm to 1 mm, for example, of 0.54 mm at the shortest cross section and 0.75 mm at the longest cross-sectional side in the case of an oval shape. The stop beads 7, 8 have a diameter of approximately 1 mm.

Particularly advantageously, a retainer according to the present invention can be used in the region of the front teeth as follows:

The retainer is used from canine tooth to canine tooth (generally with 6 connection pieces on 6 teeth).

By introducing a nickel-titanium wire in one exemplary embodiment of the present invention, the retainer can also be used in a malocclusion situation, when even smaller misalignments are present. Owing to the restoring force of the nickel-titanium wire, i.e., a kind of memory effect, this achieves a correction of the teeth misalignment.

### LIST OF REFERENCE SIGNS

1 Retainer
2 Connection piece
3 Connection piece
4 Connection piece
5 Connection piece
6 PEEK wire
7 Stop
8 Stop
9 Eyelet
A Tooth
B Tooth
C Tooth
D Tooth
P Palatal side

1. A retainer for maintaining the front teeth positioning achieved during orthodontic therapy, having at least two connection pieces for fastening the retainer on one tooth in each case and having a connection wire for establishing a connection among the teeth and/or for forming a constraint to restrict the movement capabilities of the connected teeth, wherein the connection wire is movably mounted in at least one of the connection pieces, the connection wire being at least partly made of plastic and at least one of the connection pieces being at least partly made of composite.

2. The retainer according to claim 1, wherein the connection wire is rigid in the longitudinal direction and/or has an elasticity modulus of at least 1000 MPa.

3. The retainer according toClaim 1, wherein at least one of the connection pieces at least partially surrounds the connection wire perpendicular to the longitudinal direction of the connection wire and/or lies completely on the connection wire along its circumference, by an eyelet provided for mounting the connection wire, such that a relative movement between connection wire and a particular connection piece in the longitudinal direction is allowed and a relative movement perpendicular to the longitudinal direction is permitted only within a specific area.

4. The retainer according to claim 1, wherein a stop is provided at least at one of two ends of the connection wire for the one-sided limitation of the relative movement between the connection piece and the connection wire in the longitudinal direction of the wire.

5. The retainer according to claim 4, wherein at least one of the two ends of the connection wire, the connection piece and the connection wire are permanently connected.

6. The retainer according to claim 1, wherein at least one of the connection pieces is connectable to the tooth surface in an adhesive manner.

7. The retainer according to claim 1, wherein the connection wire is designed to be non-rigid perpendicular to the longitudinal direction.

8. The retainer according to claim 1, wherein the connection wire is entirely made of plastic.

9. The retainer according to claim 1, wherein the connection wire is at least partially made of polyether ether ketone.

10. The retainer according to claim 1, wherein at least one of the connection pieces is entirely made of composite.

11. The retainer of claim 2, wherein the connection wire has an elasticity modulus of at least 3000 MPa.

12. The retainer of claim 3, wherein at least one of the connection pieces completely surrounds the connection wire perpendicular to the longitudinal direction of the connection wire.

13. The retainer of claim 3, wherein the relative movement perpendicular to the longitudinal direction is completely blocked.

14. The retainer of claim 4, wherein the stop is made of composite.

15. The retainer of claim 6, wherein the adhesive manner is achieved by an acid etching technique by etching with an acid and subsequent application of an adhesive.

16. The retainer of claim 9, wherein the connection wire is entirely made of polyether ether ketone.
